(19) United States
(12) Patent Application Publication
(10) Pub. No.: US 2024/0020806 A1
(43) Pub. Date: Jan. 18, 2024

(54) SYSTEM AND METHOD FOR DYNAMIC BINNING

(71) Applicant: Samsung Electronics Co., Ltd., Suwon-si (KR)

(72) Inventors: Gabriel T. DAGANI, Austin, TX (US); Raun KRISCH, Dripping Springs, TX (US)

(21) Appl. No.: 17/821,765

(22) Filed: Aug. 23, 2022

Related U.S. Application Data
(60) Provisional application No. 63/389,253, filed on Jul. 14, 2022.

(51) Int. Cl. G06T 5/40; G06T 7/174

(52) U.S. Cl. CPC G06T 5/40; G06T 7/174; G06T 17/20

(57) ABSTRACT

A system and method for binning. In some embodiments, the method includes segmenting a first pre-image frame into a first plurality of bins; and processing each of the bins to form a respective pixel subarray, the first plurality of bins including: a first bin having first dimensions, and a second bin having second dimensions, different from the first dimensions.

### CROSS-REFERENCE TO RELATED APPLICATION(S)

The present application claims priority to and the benefit of U.S. Provisional Application No. 63/389,253, filed Jul. 14, 2022, entitled “METHOD AND APPARATUS FOR THE IMPROVEMENT OF GPU PRIMITIVE BINNING USING VARIABLE BIN SIZE”, the entire content of which is incorporated herein by reference.

### FIELD

One or more aspects of embodiments according to the present disclosure relate to graphics processing, and more particularly to a system and method for binning.

### BACKGROUND

Graphics processing units (GPUs) may be employed to generate two-dimensional images from three-dimensional wireframe models. Such processing may require that significant numbers of calculations be performed for each image frame, and the time available may be the video frame time, e.g., the reciprocal of the video frame rate.

It is with respect to this general technical environment that aspects of the present disclosure are related.

### SUMMARY

According to an embodiment of the present disclosure, there is provided a method, including: segmenting a first pre-image frame into a first plurality of bins; and processing each of the bins to form a respective pixel subarray, the first plurality of bins including: a first bin having first dimensions, and a second bin having second dimensions, different from the first dimensions.

In some embodiments, the method further includes: segmenting a second pre-image frame into a second plurality of bins; and processing each of the second plurality of bins to form a respective pixel subarray, wherein the segmenting of the second pre-image frame is different from the segmenting of the first pre-image frame.

In some embodiments: the first dimensions include: a horizontal dimension greater than a horizontal dimension of the second dimensions, and a vertical dimension greater than a vertical dimension of the second dimensions; the first bin has a center at a first distance from a center of the first pre-image frame; and the second bin has a center at a second distance, less than the first distance, from the center of the first pre-image frame.

In some embodiments, each bin of the first plurality of bins having a center at a distance, from the center of the first pre-image frame, greater than a threshold distance has dimensions including: a horizontal dimension greater than a horizontal dimension of the second dimensions, and a vertical dimension greater than a vertical dimension of the second dimensions.

In some embodiments, the first plurality of bins further includes a third bin having third dimensions different from the first dimensions and different from the second dimensions.

In some embodiments, the third dimensions include: a horizontal dimension greater than a horizontal dimension of the first dimensions, and a vertical dimension greater than a vertical dimension of the first dimensions; and the third bin has a center at a third distance, greater than the first distance, from the center of the first pre-image frame.

In some embodiments, the first distance is a weighted Chebyshev distance.

In some embodiments: the first bin includes N pixels and n vertices; the second bin includes M pixels and m vertices; N is greater than 2 M; and n is less than 1.5 m.

In some embodiments: the first pre-image frame includes a plurality of pixels; the first plurality of bins includes a first subset of bins, the bins of the first subset together including 0.2 of the pixels of the first pre-image frame; and each of the first subset of bins containing no vertices.

According to an embodiment of the present disclosure, there is provided a system, including: a processing circuit; and memory, operatively connected to the processing circuit and storing instructions that, when executed by the processing circuit, cause the system to perform a method, the method including: segmenting a first pre-image frame into a first plurality of bins; and processing each of the bins to form a respective pixel subarray, the first plurality of bins including: a first bin having first dimensions, and a second bin having second dimensions, different from the first dimensions.

In some embodiments, the method further includes: segmenting a second pre-image frame into a second plurality of bins; and processing each of the second plurality of bins to form a respective pixel subarray, wherein: the segmenting of the second pre-image frame is different from the segmenting of the first pre-image frame.

In some embodiments: the first dimensions include: a horizontal dimension greater than a horizontal dimension of the second dimensions, and a vertical dimension greater than a vertical dimension of the second dimensions; the first bin has a center at a first distance from a center of the first pre-image frame; and the second bin has a center at a second distance, less than the first distance, from the center of the first pre-image frame.

In some embodiments, each bin of the first plurality of bins having a center at a distance, from the center of the first pre-image frame, greater than a threshold distance has dimensions including: a horizontal dimension greater than a horizontal dimension of the second dimensions, and a vertical dimension greater than a vertical dimension of the second dimensions.

In some embodiments, the first plurality of bins further includes a third bin having third dimensions different from the first dimensions and different from the second dimensions.

In some embodiments, the third dimensions include: a horizontal dimension greater than a horizontal dimension of the first dimensions, and a vertical dimension greater than a vertical dimension of the first dimensions; and the third bin has a center at a third distance, greater than the first distance, from the center of the first pre-image frame.

In some embodiments, the first distance is a weighted Chebyshev distance.

In some embodiments: the first bin includes N pixels and n vertices; the second bin includes M pixels and m vertices; N is greater than 2 M; and n is less than 1.5 m.

In some embodiments: the first pre-image frame includes a plurality of pixels; the first plurality of bins includes a first subset of bins, the bins of the first subset together including 0.2 of the pixels of the first pre-image frame; and each of the first subset of bins containing no vertices.

According to an embodiment of the present disclosure, there is provided a system, including: a means for processing; and memory, operatively connected to the means for processing and storing instructions that, when executed by the means for processing, cause the system to perform a method, the method including: segmenting a first pre-image frame into a first plurality of bins; and processing each of the bins to form a respective pixel subarray, the first plurality of bins including: a first bin having first dimensions, and a second bin having second dimensions, different from the first dimensions.

In some embodiments, the method further includes segmenting a second pre-image frame into a second plurality of bins; and processing each of the second plurality of bins to form a respective pixel subarray, wherein: the first bin includes a pixel having a first pair of coordinates in the first pre-image frame; and a third bin, of the second plurality of bins, has second dimensions different from the first dimensions and includes a pixel having coordinates equal to the first pair of coordinates in the second pre-image frame.

### BRIEF DESCRIPTION OF THE DRAWINGS

These and other features and advantages of the present disclosure will be appreciated and understood with reference to the specification, claims, and appended drawings wherein:

FIG. 1 is a block diagram of a portion of a graphics processing system, according to an embodiment of the present disclosure;

FIG. 2A is a flow chart of a portion of a method for video frame processing, according to an embodiment of the present disclosure;

FIG. 2B is a buffer diagram, according to an embodiment of the present disclosure;

FIG. 3A is a schematic drawing of an image, according to an embodiment of the present disclosure;

FIG. 3B is a schematic drawing of an image, showing bins, according to an embodiment of the present disclosure;

FIG. 3C is a schematic drawing of an image, showing bins, according to an embodiment of the present disclosure;

FIG. 3D is a schematic drawing of an image, showing bins, according to an embodiment of the present disclosure;

FIG. 4A is a flowchart of a method, according to an embodiment of the present disclosure; and

FIG. 4B is a flowchart of a method, according to an embodiment of the present disclosure.

### DETAILED DESCRIPTION

The detailed description set forth below in connection with the appended drawings is intended as a description of exemplary embodiments of a system and method for binning provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

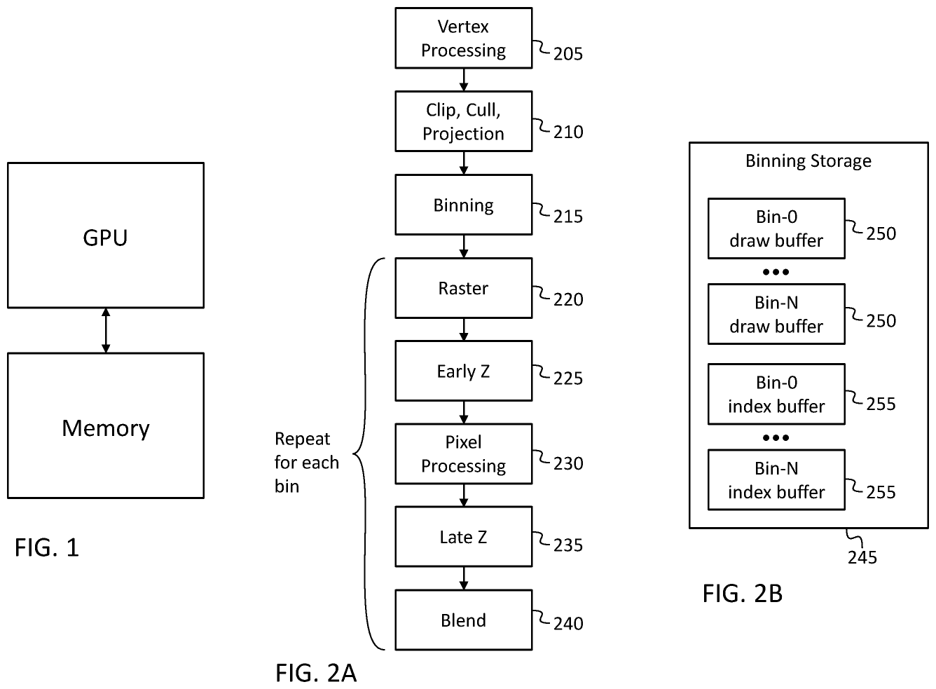

A Graphics Processing Unit (GPU) may be a processing circuit that is well suited to performing graphics processing operations, e.g., the rendering of a two-dimensional image (including, e.g., consisting of, a two-dimensional array of pixels) from a wireframe model, which may include, e.g., consist of, a plurality of triangles in three-dimensional space. Each triangle may have associated with it certain surface properties that determine how light reflects from it, as a function of the wavelength (e.g., the color) of the light, the angle of incidence, and the angle of reflection. FIG. 1 shows a GPU 105, which may be connected to a GPU memory 110. The GPU 105 may include a plurality of processor cores, which, in operation, may fetch instructions from the GPU memory 110, and execute the instructions, e.g., to perform rendering. The executing of the instructions may involve fetching data from the GPU memory 110, processing the data, and saving processed data back to the GPU memory 110.

The rendering of an image, or “renderbuffer” may include a plurality of steps such as those illustrated in FIG. 2A. These steps may include, as illustrated, a vertex processing step 205, a clip, cull, and projection step 210, and a binning step 215. The binning step 215 may use as input a “pre-image frame”, which may include inputs including vertices and vertex attributes and other data, corresponding to the rectangular image being rendered. As used herein, an “image” is the (e.g., rectangular) array of pixels that results from the rendering process, which may use a pre-image frame as input. The binning step 215 may involve dividing, or “segmenting” the image region (a rectangular region corresponding to the rendered image) into a plurality of rectangular regions, each of which may be referred as a “bin” or a “tile”. The remaining processing steps (steps 220-240) may then be performed one bin at a time. The rendering of each bin may produce an array of pixels that is a subarray of the rendered image. Several bins may be processed in parallel, for example, if the GPU 105 includes a plurality of cores, each of which may process, at any time, a respective bin. The steps performed for each bin may include but are not limited to, as illustrated, a raster step 220, an early Z step 225, a pixel processing step 230, a late Z step 235, and a blending step 240. The steps that are performed for each bin (steps 220-240) may use binning storage as illustrated in FIG. 2B; this binning storage may include draw buffers 250 and index buffers 255 within these N bins.

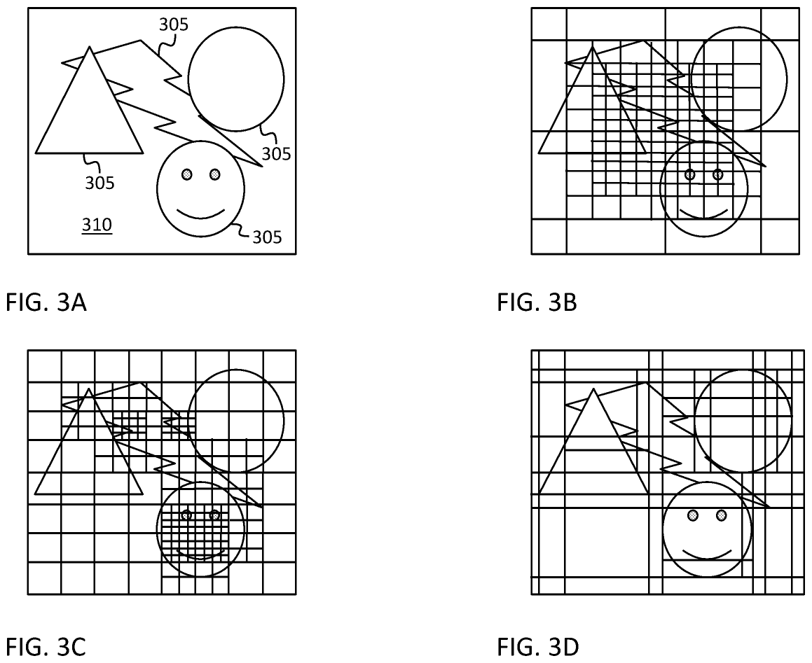

In some embodiments, the bins may be selected to have different sizes, or the segmenting of one pre-image frame may be different from the segmenting of another pre-image frame (e.g., the sizes of the bins (or the number of bins) may vary from one frame to the next). As used herein, the segmenting of a first pre-image frame may be said to be “different” from the segmenting of a second pre-image frame if any bin in the first pre-image frame overlaps with (has pixels in common with) more than one bin in the second pre-image frame. FIG. 3A shows an example of several objects 305, over a uniformly colored background 310, to be rendered to form an image. FIGS. 3B, 3C, and 3D show binning that may be performed, in various embodiments. Each bin will be rectangular, and may be defined by the coordinates of its corners, where the coordinates of a corner of a bin are the pixel offsets in the rendered image, where the pixel offset is inclusive of the pixels sharing the edge pixel offsets. Each bin may have two dimensions, a vertical (height) dimension and a horizontal (width) dimension. Each bin may have an area (defined as the number of pixels in the bin, in the rendered image). Each bin may have a center (which may be defined as the median pixel offset with regards to height and width, or as the centroid of the bin); the coordinates of the center need not be an integer (as, for example, if a bin has a width or a height that is an even number of pixels).

FIG. 3B shows binning resulting from a method that may be referred to as “foveated importance” binning. This binning method uses smaller bins near the center of the pre-image frame and larger bins farther from the center of the pre-image frame. For example, each bin that has a center at a distance, from the center of the pre-image frame, that is less than a threshold, may be a first size, and each bin that has a center at a distance, from the center of the pre-image frame, that is greater than the threshold may be second size, greater than the first size. The larger bins may be larger in both height and width than the smaller bins. If a Euclidean measure of distance used, the boundary between a region with smaller pixels and a region with larger pixels may be approximately circular. If a Manhattan measure of distance is used the boundary may be a square, rotated 45 degrees with respect to the horizontal and vertical axes. If a Chebyshev measure of distance is used, the boundary may be a square, and if a weighted Chebyshev measure of distance (in which the distance D between a first point and a second point is given by D=max(a|x₂−x₁|+|y₂−y₁|), where (x₁, y₁) are the coordinates of the first point, (x₂, y₂) are the coordinates of the second point, and a is a positive constant), the boundary may be a rectangle (as shown in FIG. 3B). In some embodiments more than one threshold may be used, with a corresponding number of boundaries (e.g., two threshold distances, and two corresponding boundaries, as shown in FIG. 3B). The outermost bins may be truncated by the edge of the pre-image frame (as shown in FIG. 3B).

FIG. 3C shows binning resulting from a method that may be referred to as “vertex count heuristic” binning. In this binning method, the bins may be smaller in regions of the pre-image frame having a high density of triangle vertices. In this embodiment, the pre-image frame may be divided into two (e.g., equal-sized) bins if it contains more than a threshold number of triangle vertices, and thereafter each bin having more than the threshold number of triangle vertices may be recursively divided into two (e.g., equal-sized) bins (e.g., using alternating vertical and horizontal dividing lines). As a result of the use of this binning method, the number of triangle vertices per bin may be approximately the same across the entire pre-image frame, even though some bins may be significantly larger than others. For example, a first bin may be twice as large (as measured by their respective areas) as a second bin, while containing fewer than 1.5 times as many triangle vertices as the second bin. In some embodiments, the number of triangles is used instead of the number of triangle vertices, to similar effect. In such an embodiment, the number of triangles in a bin may be defined as the number of triangles that are at least partially in the bin (so that a triangle that is partially in a bin and partially outside of the bin is included in the bin's triangle count).

FIG. 3D shows binning resulting from a method that may be referred to as maximizing empty rectangles. In this binning method, rectangular bins may be selected to fill every available vertex-free region, provided the bin size needed to do so is not less than a threshold minimum bin size.

The use of vertex count heuristic binning may improve wave concurrency. For example, each of several bins may be assigned to a respective core of the GPU 105. In such a situation, if the number of triangle vertices in all of the bins is approximately the same, the cores may all complete the rendering task at approximately the same time (thereby maximizing compute density and hiding any bubbles in the pipeline and improving wave concurrency). In some embodiments, the use of binning using the method of maximizing empty rectangles may improve processing efficiency by segregating a set of bins that together may include a significant number of pixels and that also may include no vertices. Bins without vertices are eliminated from further processing thereby improving compute time by reducing the overhead of swapping bins.

In some embodiments, the binning decisions for one pre-image frame are made based on the characteristics of a previously rendered pre-image frame (e.g., the pre-image frame immediately preceding the current pre-image frame). While a pre-image frame is being rendered, analysis of the triangle vertices or of the triangles in the pre-image frame may be used to determine how to segment the pre-image frame into bins, and the set of bins derived in this manner may be stored as a histogram-based lookup map, which may then be used to perform binning on one or more subsequent images frames. The lookup map may be a list of the bins, with each entry including, e.g., the coordinates of one corner of the bin and the dimensions of the bin. A reverse lookup map may also be generated and stored; the reverse lookup map may indicate, for every pixel in the pre-image frame, an identifier (e.g., an index) of the bin to which it belongs.

In some embodiments, the set of bins into which a pre-image frame is segmented may be changed relatively rarely, e.g., once every K pre-image frames, where K is an integer between 3 and 1000, or the set of bins may be static (e.g., if foveated importance binning is used).

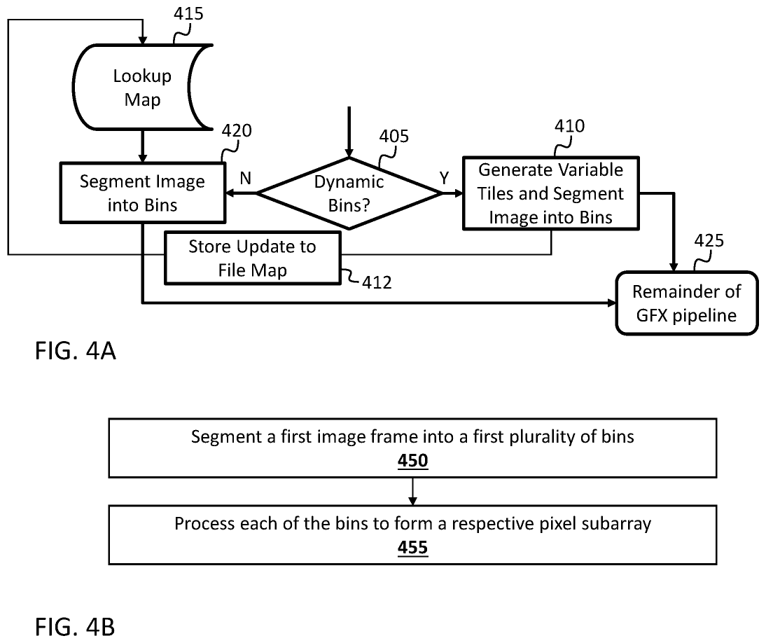

FIG. 4A is a flowchart of a method, according to some embodiments. At 405, a determination is made regarding whether dynamic binning (as opposed to static binning) is to be used (i.e., whether the bin sizes are changing with the current frame); if it is, then at 410, variable sized bins (or “tiles”) are generated, based on a binning method such as one of the binning methods described above, and the pre-image frame is segmented into bins according to the lookup map. The tiles (or an update to the tiles) may be stored, at 412, in the lookup map 415. If dynamic binning is not to be used during the present frame, then the lookup map 415 is used, at 420, to segment the pre-image frame into bins. At 425, the remaining steps of the graphics (GFX) pipeline are executed.

FIG. 4B is a flowchart of a method, according to some embodiments. The method may include segmenting, at 450, a first pre-image frame into a first plurality of bins and processing, at 455, each of the bins to form a respective pixel subarray. The first plurality of bins may include a first bin having first dimensions, and a second bin having second dimensions, different from the first dimensions. As used herein, the dimensions of a first bin are different from the dimensions of a second bin if (i) the height of the first bin is different from the height of the second bin or (ii) the width of the first bin is different from the width of the second bin. In some embodiments, the segmenting into bins may be the same for sets of frames, e.g., it may change only once every K frames, as discussed above.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, the term “array” refers to an ordered set of numbers regardless of how stored (e.g., whether stored in consecutive memory locations, or in a linked list). As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for binning have been specifically described and illustrated herein, many modifications and variations will be apparent to those skilled in the art. Accordingly, it is to be understood that a system and method for binning constructed according to principles of this disclosure may be embodied other than as specifically described herein. The invention is also defined in the following claims, and equivalents thereof.

What is claimed is:

1. A method, comprising:
segmenting a first pre-image frame into a first plurality of bins; and
processing each of the bins to form a respective pixel subarray,
the first plurality of bins comprising:
a first bin having first dimensions, and
a second bin having second dimensions, different from the first dimensions.

2. The method of claim 1, further comprising:
segmenting a second pre-image frame into a second plurality of bins; and
processing each of the second plurality of bins to form a respective pixel subarray,
wherein the segmenting of the second pre-image frame is different from the segmenting of the first pre-image frame.

3. The method of claim 1, wherein:
the first dimensions include:
a horizontal dimension greater than a horizontal dimension of the second dimensions, and
a vertical dimension greater than a vertical dimension of the second dimensions;
the first bin has a center at a first distance from a center of the first pre-image frame; and
the second bin has a center at a second distance, less than the first distance, from the center of the first pre-image frame.

4. The method of claim 3, wherein each bin of the first plurality of bins having a center at a distance, from the center of the first pre-image frame, greater than a threshold distance has dimensions including:
a horizontal dimension greater than a horizontal dimension of the second dimensions, and
a vertical dimension greater than a vertical dimension of the second dimensions.

5. The method of claim 3, wherein the first plurality of bins further comprises a third bin having third dimensions different from the first dimensions and different from the second dimensions.

6. The method of claim 5, wherein:
the third dimensions include:
a horizontal dimension greater than a horizontal dimension of the first dimensions, and
a vertical dimension greater than a vertical dimension of the first dimensions; and
the third bin has a center at a third distance, greater than the first distance, from the center of the first pre-image frame.

7. The method of claim 3, wherein the first distance is a weighted Chebyshev distance.

8. The method of claim 1, wherein:
the first bin includes N pixels and n vertices;
the second bin includes M pixels and m vertices;
N is greater than 2 M; and
n is less than 1.5 m.

9. The method of claim 1, wherein:
the first pre-image frame comprises a plurality of pixels;
the first plurality of bins comprises a first subset of bins, the bins of the first subset together comprising 0.2 of the pixels of the first pre-image frame; and
each of the first subset of bins containing no vertices.

10. A system, comprising:
a processing circuit; and
memory, operatively connected to the processing circuit and storing instructions that, when executed by the processing circuit, cause the system to perform a method, the method comprising:
segmenting a first pre-image frame into a first plurality of bins; and
processing each of the bins to form a respective pixel subarray,
the first plurality of bins comprising:
a first bin having first dimensions, and
a second bin having second dimensions, different from the first dimensions.

11. The system of claim 10, wherein the method further comprises:
segmenting a second pre-image frame into a second plurality of bins; and
processing each of the second plurality of bins to form a respective pixel subarray,
wherein:
the segmenting of the second pre-image frame is different from the segmenting of the first pre-image frame.

12. The system of claim 10, wherein:
the first dimensions include:
a horizontal dimension greater than a horizontal dimension of the second dimensions, and
a vertical dimension greater than a vertical dimension of the second dimensions;
the first bin has a center at a first distance from a center of the first pre-image frame; and
the second bin has a center at a second distance, less than the first distance, from the center of the first pre-image frame.

13. The system of claim 12, wherein each bin of the first plurality of bins having a center at a distance, from the center of the first pre-image frame, greater than a threshold distance has dimensions including:
a horizontal dimension greater than a horizontal dimension of the second dimensions, and
a vertical dimension greater than a vertical dimension of the second dimensions.

14. The system of claim 12, wherein the first plurality of bins further comprises a third bin having third dimensions different from the first dimensions and different from the second dimensions.

15. The system of claim 14, wherein:
the third dimensions include:
a horizontal dimension greater than a horizontal dimension of the first dimensions, and
a vertical dimension greater than a vertical dimension of the first dimensions; and
the third bin has a center at a third distance, greater than the first distance, from the center of the first pre-image frame.

16. The system of claim 12, wherein the first distance is a weighted Chebyshev distance.

17. The system of claim 10, wherein:
the first bin includes N pixels and n vertices;
the second bin includes M pixels and m vertices;
N is greater than 2 M; and
n is less than 1.5 m.

18. The system of claim 10, wherein:
the first pre-image frame comprises a plurality of pixels;
the first plurality of bins comprises a first subset of bins, the bins of the first subset together comprising 0.2 of the pixels of the first pre-image frame; and
each of the first subset of bins containing no vertices.

19. A system, comprising:
a means for processing; and
memory, operatively connected to the means for processing and storing instructions that, when executed by the means for processing, cause the system to perform a method, the method comprising:
segmenting a first pre-image frame into a first plurality of bins; and
processing each of the bins to form a respective pixel subarray,
the first plurality of bins comprising:
a first bin having first dimensions, and
a second bin having second dimensions, different from the first dimensions.

20. The system of claim 19, wherein the method further comprises segmenting a second pre-image frame into a second plurality of bins; and
processing each of the second plurality of bins to form a respective pixel subarray,
wherein:
the first bin includes a pixel having a first pair of coordinates in the first pre-image frame; and
a third bin, of the second plurality of bins, has second dimensions different from the first dimensions and includes a pixel having coordinates equal to the first pair of coordinates in the second pre-image frame.
